(19) United States
(12) Patent Application Publication
(10) Pub. No.: US 2009/0324102 A1
(43) Pub. Date: Dec. 31, 2009

(54) IMAGE PROCESSING APPARATUS AND METHOD AND PROGRAM

(76) Inventors: Shintaro OKADA, Tokyo (JP); Kazuhiko NISHIBORI, Kanagawa (JP); Tomohiro NISHI, Tokyo (JP); Toshinori IHARA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/492,711

(22) Filed: Jun. 26, 2009

(30) Foreign Application Priority Data
Jun. 27, 2008 (JP) P2008-168235

(51) Int. Cl. G06K 9/68

(52) U.S. Cl. 382/218

(57) ABSTRACT

An image processing apparatus includes a difference calculation unit that obtains a luminance difference between images of two successive frames; an average calculation unit that calculates the average of luminance differences obtained for a predetermined number of successive frames; a change determination unit that determines, for each frame of the predetermined number of the successive frames, whether images of two successive frames including the frame are the same by comparing the luminance difference obtained for the frame with the average; and a display pattern determination unit that determines a temporal display pattern of images of the predetermined number of the successive frames from among a plurality of display patterns including a display pattern in which groups each having a certain number of successive frames in which the same image is displayed are regularly repeated, using a determination result obtained by the change determination unit.

### BACKGROUND OF THE INVENTION

1. Field of the Invention

The present invention relates to an image processing apparatus and method and a program, and more particularly to an image processing apparatus and method and a program that determine a display pattern of an image more quickly and with more certainty.

2. Description of the Related Art

For example, in a case where an input image which is a moving image is to be displayed, a technology called frame rate conversion in which a frame is interpolated in an input image by motion compensation is generally popular. That is, in frame rate conversion, a new frame of the input image is generated between a predetermined frame of an input image and a frame of the input image different from the predetermined frame by motion compensation using the frames and motion vectors.

Here, in some input images, an image of a predetermined frame may be simply used as an image of the next frame. For example, different images are displayed from frame to frame in a general progressive moving image; however, the same image is displayed in two successive frames in a moving image of content such as animation.

In this way, if a display pattern of an input image is different, for example, different images are displayed from frame to frame in the input image or the same image is repeatedly displayed in successive frames, a frame to be used for motion compensation in frame rate conversion changes. Thus, if a display pattern of an input image is not specified, for example, different frames in which the same image is displayed may be used to generate a new interpolation frame.

Thus, as a method for determining a display pattern of an input image, a method for determining a display pattern by performing threshold processing on a difference between images of successive frames (for example, see Japanese Unexamined Patent Application Publication No. 2005-318611) or a method for determining a display pattern using a state machine has been proposed. In a display device provided with a mechanism for determining a display pattern of an input image in this way, when the input image is played back, frame rate conversion is performed in accordance with a determination result regarding the display pattern.

### SUMMARY OF THE INVENTION

However, it is difficult to quickly determine a display pattern of an input image with certainty using the above-described technology.

For example, in a method that uses a state machine, a long period of time is necessary to determine a display pattern since there are many conditional branches. Moreover, since it takes a long time to select an appropriate frame to be used for frame rate conversion after a display pattern has been determined, a period during which an appropriate frame is not used becomes long and thus the image quality of the input image may be degraded.

Furthermore, in a method that determines a display pattern by means of threshold processing, if a threshold to be used in threshold processing is particularly a fixed value, it is difficult to set a threshold appropriate for an input image. Thus, if a threshold is not appropriately set, a display pattern may be wrongly determined depending on the magnitude of a difference between successive frames of the input image.

It is desirable to enable determination of a display pattern of an input image more quickly and with more certainty.

An image processing apparatus according to an embodiment of the present invention includes: difference calculation means for obtaining a luminance difference between images of two successive frames; average calculation means for calculating the average of luminance differences obtained for a predetermined number of successive frames, each of the luminance differences being obtained for a corresponding one of the predetermined number of the successive frames; change determination means for determining, for each frame of the predetermined number of the successive frames, whether images of two successive frames including the frame are the same by comparing the luminance difference obtained for the frame with the average; and display pattern determination means for determining a temporal display pattern of images of the predetermined number of the successive frames from among a plurality of display patterns including a display pattern in which groups each having a certain number of successive frames in which the same image is displayed are regularly repeated, using a determination result regarding the predetermined number of the frames, the determination result being obtained by the change determination means.

The image processing apparatus may further include frame interpolation means for performing motion compensation using an image of a first frame and an image of a second frame specified, from among the images of the predetermined number of the frames, by a determination result obtained by the change determination means and a determination result regarding the display pattern, and for generating an image of a frame to be interpolated between the first and second frames.

The image processing apparatus may further include comparison means for comparing a difference between the maximum and minimum values of the luminance differences obtained for the predetermined number of the frames with the average. The display pattern determination means may determine the display pattern using the determination result obtained by the change determination means and a comparison result obtained by the comparison means.

The image processing apparatus may further include number-of-times calculation means for obtaining the number of times the same image is displayed in the predetermined number of the frames using the determination result obtained by the change determination means. The display pattern determination means may determine the display pattern using the determination result obtained by the change determination means and the result regarding the number of times the same image is displayed obtained by the number-of-times calculation means.

The image processing apparatus may further include reduced image generation means for generating a reduced image of an image by reducing the number of pixels of the image. The difference calculation means may obtain the luminance difference using the reduced image.

An image processing method and a program according to an embodiment of the present invention include the steps of: obtaining a luminance difference between images of two successive frames; calculating the average of luminance differences obtained for a predetermined number of successive frames, each of the luminance differences being obtained for a corresponding one of the predetermined number of the successive frames; determining, for each frame of the predetermined number of the successive frames, whether images of two successive frames including the frame are the same by comparing the luminance difference obtained for the frame with the average; and determining a temporal display pattern of images of the predetermined number of the successive frames from among a plurality of display patterns including a display pattern in which groups each having a certain number of successive frames in which the same image is displayed are regularly repeated, using a determination result regarding the predetermined number of the frames, the determination result as to whether the images of the two successive frames including the frame are the same.

According to the embodiments of the present invention, a luminance difference between images of two successive frames is obtained; the average of luminance differences obtained for a predetermined number of successive frames is calculated, each of the luminance differences being obtained for a corresponding one of the predetermined number of the successive frames; for each frame of the predetermined number of the successive frames, whether images of two successive frames including the frame are the same by comparing the luminance difference obtained for the frame with the average is determined; and a temporal display pattern of images of the predetermined number of the successive frames is determined from among a plurality of display patterns including a display pattern in which groups each having a certain number of successive frames in which the same image is displayed are regularly repeated, using a determination result regarding the predetermined number of the frames, the determination result as to whether the images of the two successive frames including the frame are the same.

According to an embodiment of the present invention, a display pattern of an input image can be determined more quickly and with more certainty.

### BRIEF DESCRIPTION OF THE DRAWINGS

FIG. 1 is a diagram illustrating display patterns of input images;

FIG. 2 is a block diagram showing an example of a structure of an embodiment of an image conversion apparatus to which the present invention is applied;

FIG. 3 is a diagram showing an example of a more detailed structure of a film mode determination unit;

FIG. 4 is a diagram showing an example of a more detailed structure of an interframe change detector;

FIG. 5 is a diagram showing an example of a more detailed structure of a film pattern determination unit;

FIG. 6 is a flowchart illustrating frame rate conversion processing;

FIG. 7 is a flowchart illustrating film mode determination processing;

FIG. 8 is a diagram illustrating detection of motion between frames;

FIGS. 9A to 9C are diagrams illustrating detection of motion between frames;

FIGS. 10A to 10C are diagrams showing display patterns of film modes;

FIG. 11 is a diagram illustrating an example of frame rate conversion;

FIG. 12 is a diagram illustrating the example of frame rate conversion;

FIG. 13 is a diagram illustrating an example of frame rate conversion;

FIG. 14 is a diagram illustrating the example of frame rate conversion;

FIG. 15 is a diagram illustrating an example of frame rate conversion;

FIG. 16 is a diagram illustrating the example of frame rate conversion; and

FIG. 17 is a diagram showing an example of a structure of a computer.

### DESCRIPTION OF THE PREFERRED EMBODIMENTS

In the following, embodiments of the present invention will be described with reference to the drawings.

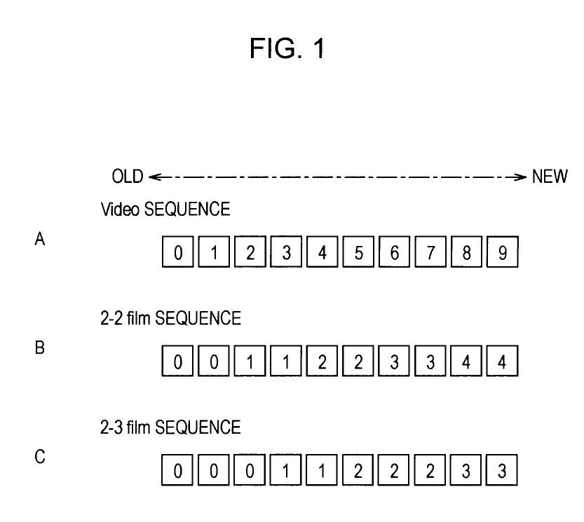

First, with reference to parts A to C of FIG. 1, a display pattern of an input image to be determined in an image conversion apparatus according to an embodiment of the present invention will be described. Here, a display pattern of an input image is a temporal display pattern of the input image, for example, different images are displayed from frame to frame or groups each having a certain number of successive frames in which the same image is displayed are regularly repeated.

Here, in parts A to C of FIG. 1, the horizontal direction indicates time, and each square shape represents an image of one of the frames of the input image. In parts A to C of FIG. 1, images of frames are arranged in order starting from an image having the oldest display time in a direction from left to right in parts A to C of FIG. 1. The images represented by square shapes having the same number inside are the same image.

In a display pattern shown in part A of FIG. 1, different images are displayed from frame to frame in successive frames. For example, many television broadcasting programs have this display pattern. In the following, the display pattern in which different images are displayed from frame to frame is referred to as “Video”.

In a display pattern shown in part B of FIG. 1, the same image is displayed in two temporally successive frames. That is, for each of the numbers, an image represented by the number is repeatedly displayed in two successive frames. For example, this display pattern is obtained when the frame rate of a moving image of content such as animation is converted for television broadcasting. In the following, the display pattern shown in part B of FIG. 1 is referred to as “2-2 film”.

In a display pattern shown in part C of FIG. 1, the same image is displayed in three successive frames, and thereafter a different image is displayed in the next two successive frames. Images are displayed while such a pattern is repeated. For example, this display pattern is obtained when the frame rate of a moving image created for being played at theaters such as movie theaters is converted for television broadcasting. In the following, the display pattern shown in part C of FIG. 1 is referred to as “2-3 film”.

An image conversion apparatus to which an embodiment of the present invention is applied uses an input image which is a moving image being input, and determines a temporal display pattern of the input image from among “Video”, “2-2 film”, and “2-3 film”. In accordance with a determination result, the frame rate of the input image is converted. In the following, a display pattern of the input image is also referred to as a film mode, and determination of a display pattern (film mode) is also referred to as film mode determination.

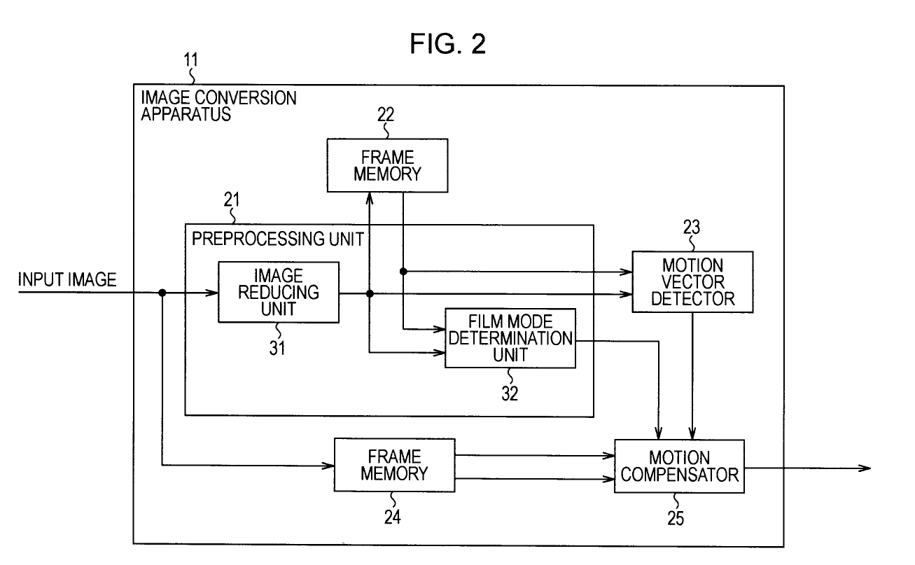

FIG. 2 is a block diagram showing an example of a structure of an embodiment of an image conversion apparatus to which the present invention is applied.

An image conversion apparatus 11 includes a preprocessing unit 21, a frame memory 22, a motion vector detector 23, a frame memory 24, and a motion compensator 25. An input image input to the image conversion apparatus 11 is supplied to the preprocessing unit 21 and the frame memory 24 in units of one frame.

The preprocessing unit 21 determines a film mode of the input image, which has been input. The preprocessing unit 21 includes an image reducing unit 31 and a film mode determination unit 32.

The image reducing unit 31 reduces the number of pixels of a supplied image and generates a reduced image that is a smaller image than the supplied image, that is, an image having a smaller number of pixels. The image reducing unit 31 supplies the generated reduced image to the frame memory 22, the film mode determination unit 32, and the motion vector detector 23.

The film mode determination unit 32 determines the film mode of the input image using the reduced image supplied from the image reducing unit 31 and a reduced image that is supplied from the frame memory 22 and that is a reduced image of a frame temporally one frame previous to a frame of the reduced image supplied from the image reducing unit 31. The film mode determination unit 32 supplies the determination result to the motion compensator 25.

The frame memory 22 holds the reduced image supplied from the image reducing unit 31 only for a time period during which one frame is displayed, and thereafter supplies the reduced image to the film mode determination unit 32 and the motion vector detector 23. The motion vector detector 23 detects motion vectors of the input image using the reduced image supplied from the image reducing unit 31 and the reduced image supplied from the frame memory 22. The motion vector detector 23 supplies the detected motion vectors to the motion compensator 25.

The frame memory 24 is a memory for holding a supplied image only for a time period during which one frame is displayed. The frame memory 24 supplies a supplied image and an image that has been held by the frame memory 24 to the motion compensator 25. Thus, images of two temporally successive frames are supplied from the frame memory 24 to the motion compensator 25.

While referring to the determination result supplied from the film mode determination unit 32, the motion compensator 25 performs frame rate conversion on the input image using the motion vectors supplied from the motion vector detector 23 and the images supplied from the frame memory 24. That is, the motion compensator 25 performs motion compensation using the supplied images and motion vectors, and generates an image of a new frame to be interpolated between successive frames. Here, in the following, a frame that is to be or is interpolated by motion compensation is also referred to as an interpolation frame.

If the frame rate of the input image is converted by the motion compensator 25, the input image whose frame rate has been converted is supplied from the motion compensator 25 to a display unit, which is not shown, such as a liquid crystal display and displayed thereon.

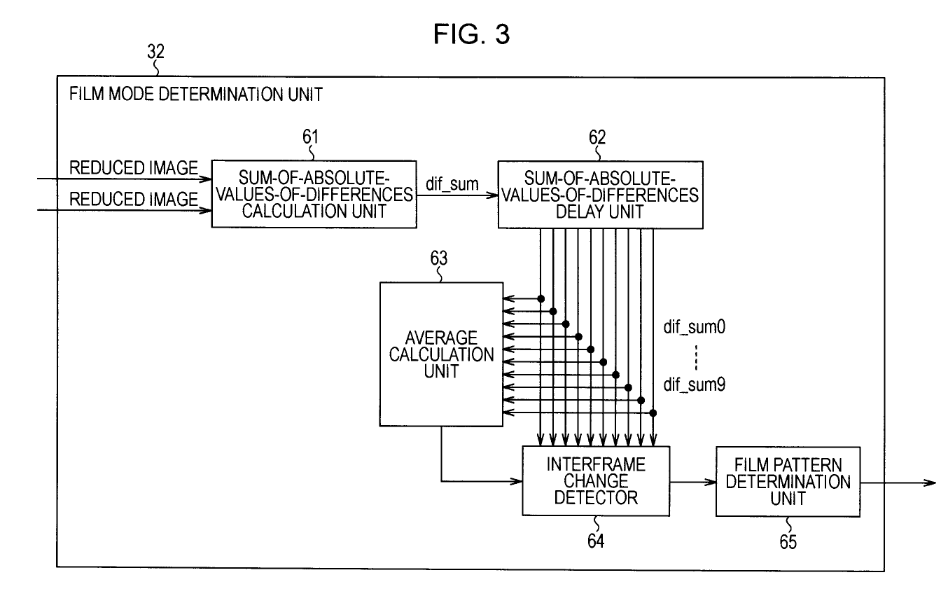

Next, FIG. 3 is a diagram showing an example of a more detailed structure of the film mode determination unit 32 shown in FIG. 2. The film mode determination unit 32 includes a sum-of-absolute-values-of-differences calculation unit 61, a sum-of-absolute-values-of-differences delay unit 62, an average calculation unit 63, an interframe change detector 64, and a film pattern determination unit 65.

The sum-of-absolute-values-of-differences calculation unit 61 calculates the sum of absolute values of differences between luminance values of the reduced images supplied from the image reducing unit 31 and the frame memory 22, as a luminance difference between the reduced images. The sum-of-absolute-values-of-differences calculation unit 61 supplies the sum of the absolute values of the differences to the sum-of-absolute-values-of-differences delay unit 62.

The sum-of-absolute-values-of-differences delay unit 62 temporarily holds and delays the sum of the absolute values of the differences supplied from the sum-of-absolute-values-of-differences calculation unit 61. Moreover, the sum-of-absolute-values-of-differences delay unit 62 supplies sums of absolute values of differences regarding the last ten frames including a frame currently being processed, to the average calculation unit 63 and the interframe change detector 64. That is, if the frame currently being processed is referred to as the current frame, the sum-of-absolute-values-of-differences delay unit 62 supplies sums of absolute values of differences dif-sum0 to dif-sum9, each of which is calculated for a corresponding one of the current frame and nine frames previous to the current frame, to the average calculation unit 63 and the interframe change detector 64.

The average calculation unit 63 calculates an average dif-sum-ave of the sums of the absolute values of the differences dif-sum0 to dif-sum9 supplied from the sum-of-absolute-values-of-differences delay unit 62, and supplies the average dif-sum-ave to the interframe change detector 64. Moreover, the average calculation unit 63 obtains the maximum and minimum values of the sums of the absolute values of the differences dif-sum0 to dif-sum9 supplied from the sum-of-absolute-values-of-differences delay unit 62, and supplies the maximum and minimum values to the interframe change detector 64.

The interframe change detector 64 generates a change signal mdc and a number-of-changes signal CHANGES, using the average and the maximum and minimum values supplied from the average calculation unit 63 and the sums of the absolute values of the differences supplied from the sum-of-absolute-values-of-differences delay unit 62. The interframe change detector 64 supplies the change signal mdc and the number-of-changes signal CHANGES to the film pattern determination unit 65.

Here, the change signal mdc is a signal for indicating, for each of the last ten frames including the current frame, whether an image of the frame is the same as an image of a frame temporally one frame previous thereto. If a case where an image of a subject frame is different from an image of the frame temporally one frame previous thereto is referred to as that motion exists between frames, the change signal mdc includes information regarding whether motion exists for each of the last ten frames of the input image. Moreover, the number-of-changes signal CHANGES is a signal indicating the number of times motion has been detected between frames in the last ten frames of the input image.

The film pattern determination unit 65 generates a film mode signal for indicating a film mode of the input image and a film sequence signal for specifying a position of the current frame in the display pattern, using the change signal mdc and the number-of-changes signal CHANGES supplied from the interframe change detector 64. The film pattern determination unit 65 supplies the generated film mode signal and the generated film sequence signal to the motion compensator 25.

For example, in an input image whose film mode is “2-3 film” as shown in FIG. 1C, after the same image is displayed in three successive frames, an image different from the displayed image is displayed in the next two successive frames. Such a display pattern is repeated. That is, in the film mode “2-3 film”, a display pattern of five successive frames, for example, frames starting from a frame positioned at the left end and having a number 0 to a frame positioned fifth from the left end and having a number 1 in FIG. 1C, is repeated.

Thus, if the current frame can be specified from among the five frames, whether the image of the current frame is the same as images of the other frames and the like can be determined with certainty. Thus, a film sequence signal is generated that indicates which one of the frames that are the unit of repetition in a display pattern the current frame is, in accordance with whether motion exists between frames among the last few frames including the current frame.

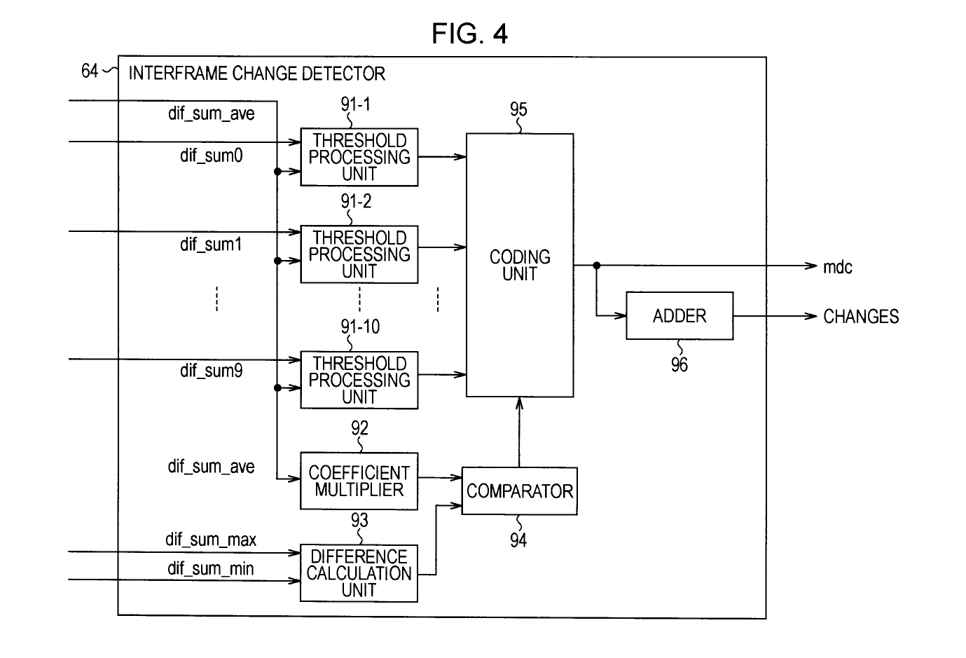

More specifically, the interframe change detector 64 shown in FIG. 3 is configured as shown in FIG. 4.

That is, the interframe change detector 64 includes threshold processing units 91-1 to 91-10 (threshold processing units 91-3 to 91-9 are not shown), a coefficient multiplier 92, a difference calculation unit 93, a comparator 94, a coding unit 95, and an adder 96.

The average dif-sum-ave supplied from the average calculation unit 63 is supplied to the threshold processing units 91-1 to 91-10 and the coefficient multiplier 92. The maximum and minimum values of the sums of the absolute values of the differences supplied from the average calculation unit 63 are supplied to the difference calculation unit 93. The sums of the absolute values of the differences dif-sum0 to dif-sum9 supplied from the sum-of-absolute-values-of-differences delay unit 62 are supplied to the threshold processing units 91-1 to 91-10, respectively.

The threshold processing units 91-1 to 91-10 perform threshold processing on the sums of the absolute values of the differences dif-sum0 to dif-sum9 supplied from the sum-of-absolute-value-of-difference delay unit 62, respectively, using the average dif-sum-ave supplied from the average calculation unit 63 as a threshold, and supply the processing results to the coding unit 95. Here, in the following, in a case where it is not necessary to differentiate the threshold processing units 91-1 to 91-10 from each other, they are simply referred to as threshold processing units 91.

The coefficient multiplier 92 multiplies the average dif-sum-ave supplied from the average calculation unit 63 by a predetermined coefficient, and supplies a resulting value to the comparator 94. The difference calculation unit 93 calculates a difference between the maximum and minimum values supplied from the average calculation unit 63 and supplies the calculated difference to the comparator 94.

The comparator 94 compares an average supplied from the coefficient multiplier 92 with the difference supplied from the difference calculation unit 93, and supplies a comparison result to the coding unit 95. That is, whether the input image is regarded as a film video is determined in accordance with the comparison result obtained by comparing the difference with the average using the comparator 94. Here, the term “film video” means an input image whose film mode is “2-2 film” or “2-3 film”.

For example, if an input image whose film mode is “Video” is input, images of frames differ from frame to frame. Thus, in general, it should be extremely rare that the difference between the maximum and minimum values of the sums of the absolute values of the differences is greater than the average. In contrast, if an input image whose film mode is “2-2 film” or “2-3 film” is input, the difference between the maximum and minimum values should be sufficiently greater than the average.

Thus, the comparator 94 compares the difference between the maximum and minimum values with the average and supplies, as a comparison result, information indicating whether the film mode of the input image is either one of “2-2 film” and “2-3 film” or “Video” to the coding unit 95.

The coding unit 95 generates the change signal mdc using results of threshold processing supplied from the threshold processing units 91-1 to 91-10 while referring to the comparison result supplied from the comparator 94, and supplies the change signal mdc to the adder 96 and the film pattern determination unit 65. Here, the change signal mdc is data of ten bits. Each bit of the change signal mdc indicates whether motion exists between frames for a corresponding one of the last ten frames. More specifically, a bit value of a bit of the change signal mdc, the bit corresponding to a predetermined frame, is “1” when motion exists between frames and “0” when motion does not exist between frames for the predetermined frame.

The adder 96 generates the number-of-changes signal CHANGES by calculating the sum of the values of the bits of the change signal mdc supplied from the coding unit 95, and supplies the number-of-changes signal CHANGES to the film pattern determination unit 65. That is, each bit of the change signal mdc indicates whether motion exists between frames for a corresponding one of the frames, and the value of the bit is “1” when motion exists. Thus, the sum of the values of the bits indicates the number of times motion has been detected between frames in the last ten frames.

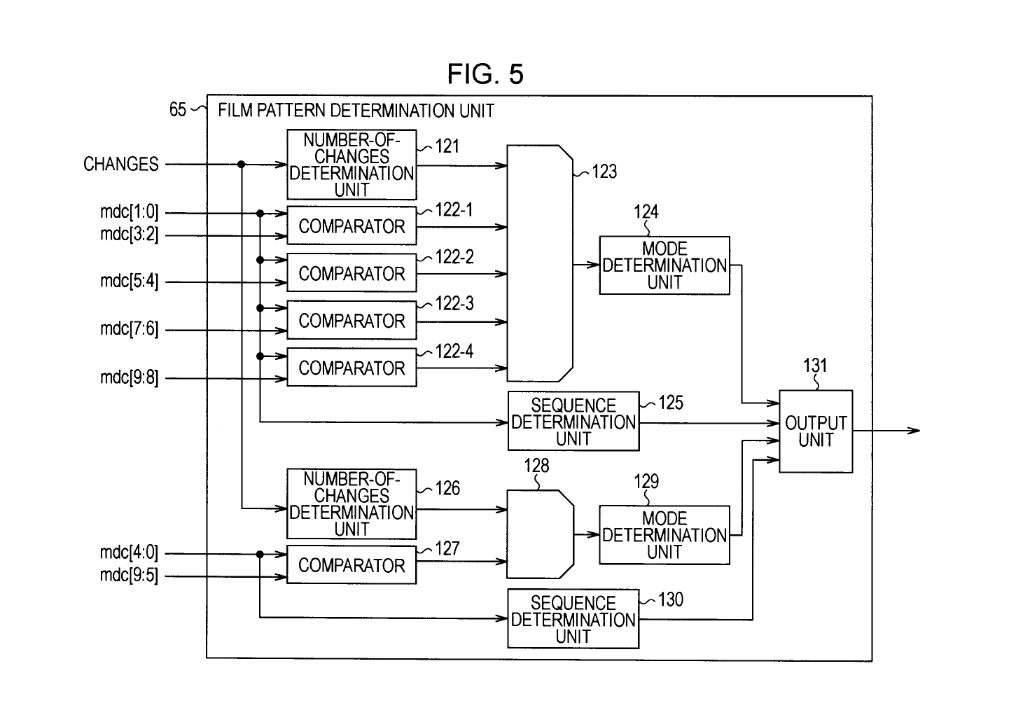

More specifically, the film pattern determination unit 65 shown in FIG. 3 is configured as shown in FIG. 5. That is, the film pattern determination unit 65 includes a number-of-changes determination unit 121, comparators 122-1 to 122-4, an AND circuit 123, a mode determination unit 124, a sequence determination unit 125, a number-of-changes determination unit 126, a comparator 127, an AND circuit 128, a mode determination unit 129, a sequence determination unit 130, and an output unit 131.

Here, the number-of-changes signal CHANGES supplied from the adder 96 is supplied to the number-of-changes determination unit 121 and the number-of-changes determination unit 126. Moreover, parts of the change signal mdc supplied from the coding unit 95 are supplied to the comparators 122-1 to 122-4, the sequence determination unit 125, the comparator 127, and the sequence determination unit 130.

Here, if a portion between the i-th bit from the last (lowest bit) of the change signal mdc (where 0≦i≦9) and the j-th bit from the last of the change signal mdc (where 0≦j≦9) is treated as a change signal mdc[j:i], a change signal mdc[1:0] is supplied to the comparators 122-1 to 122-4, and change signals mdc[3:2], mdc[5:4], mdc[7:6], and mdc[9:8] are supplied to the comparators 122-1 to 122-4, respectively.

Moreover, the change signal mdc[1:0] is supplied to the sequence determination unit 125. Furthermore, change signals mdc[4:0] and mdc[9:5] are supplied to the comparator 127. The change signal mdc[4:0] is supplied to the sequence determination unit 130.

In the film pattern determination unit 65, whether the film mode of the input image is “2-2 film” is determined by the number-of-changes determination unit 121 through to the mode determination unit 124, and whether the film mode of the input image is “2-3 film” is determined by the number-of-changes determination unit 126 through to the mode determination unit 129.

The number-of-changes determination unit 121 supplies a bit value corresponding to the number-of-changes signal CHANGES supplied from the adder 96 to the AND circuit 123. The comparators 122-1 to 122-4 supply, to the AND circuit 123, bit values corresponding to comparison results obtained by comparing the change signal mdc[1:0] with the change signals mdc[3:2], mdc[5:4], mdc[7:6], and mdc[9:], respectively. Here, in the following, if it is not necessary to differentiate the comparators 122-1 to 122-4 from each other, they are simply referred to as comparators 122.

The AND circuit 123 calculates the logical ANDs between the bit values supplied from the number-of-changes determination unit 121 and the comparators 122, and supplies the calculation result to the mode determination unit 124. The mode determination unit 124 generates the film mode signal of the input image using the calculation result supplied from the AND circuit 123, and supplies the film mode signal to the output unit 131. The sequence determination unit 125 generates the film sequence signal of the input image using the change signal mdc[1:0] supplied from the coding unit 95, and supplies the film sequence signal to the output unit 131.

The number-of-changes determination unit 126 supplies, to the AND circuit 128, a bit value corresponding to the number-of-changes signal CHANGES supplied from the adder 96. The comparator 127 supplies, to the AND circuit 128, a bit value corresponding to a comparison result obtained by comparing between the change signals mdc[4:0] and mdc[9:5] supplied from the coding unit 95.

The AND circuit 128 calculates the logical AND between the bit values supplied from the number-of-changes determination unit 126 and the comparator 127, and supplies the calculation result to the mode determination unit 129. The mode determination unit 129 generates the film mode signal of the input image using the calculation result supplied from the AND circuit 128, and supplies the film mode signal to the output unit 131. The sequence determination unit 130 generates the film sequence signal of the input image using the change signal mdc[4:0] supplied from the coding unit 95, and supplies the film sequence signal to the output unit 131.

The output unit 131 supplies a final film mode signal to the motion compensator 25 using the film mode signals supplied from the mode determination units 124 and 129. Moreover, the output unit 131 supplies a final film sequence signal to the motion compensator 25 using the film sequence signals supplied from the sequence determination units 125 and 130.

If an input image is supplied to the image conversion apparatus 11 and a command to execute conversion of the frame rate of the input image is input, the image conversion apparatus 11 starts frame rate conversion processing, which is processing in which the frame rate of an input image is converted in response to such a command and the input image having the converted frame rate is output.

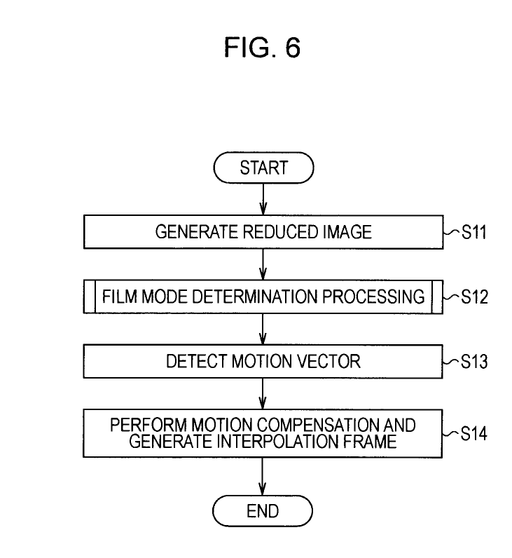

In the following, frame rate conversion processing performed by the image conversion apparatus 11 will be described with reference to a flowchart shown in FIG. 6.

In step S11, the image reducing unit 31 reduces the number of pixels of a supplied image by performing filtering processing on the supplied image, and generates a reduced image. The image reducing unit 31 supplies the generated reduced image to the frame memory 22, the film mode determination unit 32, and the motion vector detector 23.

The frame memory 22 holds a reduced image of the current frame supplied from the image reducing unit 31 and supplies a reduced image that has been held by the frame memory 22, that is, the reduced image of the frame temporally one frame previous to the current frame to the film mode determination unit 32 and the motion vector detector 23.

In step S12, the film mode determination unit 32 performs film mode determination processing and supplies a determination result to the motion compensator 25. In film mode determination processing, the film mode determination unit 32 generates a film mode signal and a film sequence signal using the reduced images supplied from the image reducing unit 31 and the frame memory 22, and supplies the film mode signal and the film sequence signal to the motion compensator 25. The details of film mode determination processing will be described below.

In step S13, the motion vector detector 23 detects motion vectors of pixels of the reduced image of the frame that is one frame previous to the current frame and that is supplied from the frame memory 22, using the reduced images supplied from the image reducing unit 31 and the frame memory 22. Motion vector detection is performed by using, for example, block matching or a gradient method.

If the motion vectors of the reduced image have been detected, the motion vector detector 23 supplies the detected motion vectors to the motion compensator 25. More specifically, the motion vectors of the pixels of the reduced image are upsampled and treated as the motion vectors of the pixels of the image of the frame one frame previous to the current frame. The motion vectors are supplied to the motion compensator 25. This upsampling may be performed by the motion compensator 25.

The frame memory 24 holds the image of the supplied current frame for a time period during which one frame is displayed, and also supplies the image of the current frame and the image of the frame that has been held by the frame memory 24 to the motion compensator 25.

In step S14, the motion compensator 25 refers to the film mode signal and the film sequence signal supplied from the film mode determination unit 32, performs motion compensation using the images supplied from the frame memory 24 and the motion vectors supplied from the motion vector detector 23, and generates an interpolation frame of the input image.

More specifically, the motion compensator 25 holds images of frames temporally previous to the current frame and the motion vectors of the images, the images of the frames having been already supplied to the motion compensator 25. The motion compensator 25 selects frames specified by the film mode signal and the film sequence signal from among the frames being held by the motion compensator 25, the current frame, and the frame one frame previous to the current frame. Moreover, the motion compensator 25 selects motion vectors of a frame specified by the film mode signal and the film sequence signal.

Then, the motion compensator 25 uses the images of the selected frames and the motion vectors of the selected frame and generates an interpolation frame of the input image by motion compensation. The motion compensator 25 supplies, to a display unit provided after the motion compensator 25, the input image whose frame rate has been converted and that includes the image of the generated interpolation frame and the images of the frames supplied from the frame memory 24. The input image whose frame rate has been converted is displayed on the display unit, and frame rate conversion processing is completed. In the image conversion apparatus 11, frame rate conversion processing is performed every time one frame of the input image is input, and the input image including interpolation frames is displayed.

In this way, the image conversion apparatus 11 determines the film mode of the input image, which has been input, and converts the frame rate of the input image using appropriate frames specified in accordance with the determination result.

In this way, the frame rate of the input image can be converted using images of appropriate frames and motion vectors of an appropriate frame by determining the film mode of the input image, whereby the image quality of the input image can be prevented from being degraded.

Moreover, in the image conversion apparatus 11, a mechanism that determines the film mode, that is, the film mode determination unit 32 is provided before the motion vector detector 23 within the image conversion apparatus 11. Thus, it is not necessary to additionally provide a frame memory for film mode determination and the like. That is, since the image conversion apparatus 11 is configured to obtain an image to be used when the film mode determination unit 32 determines the film mode from the frame memory 22 that supplies an image to the motion vector detector 23, the number of parts can be reduced.

Furthermore, the amount of processing necessary to perform film mode determination and motion vector detection can be significantly reduced by using a reduced image of a supplied image, whereby film mode determination and frame rate conversion can be more quickly performed.

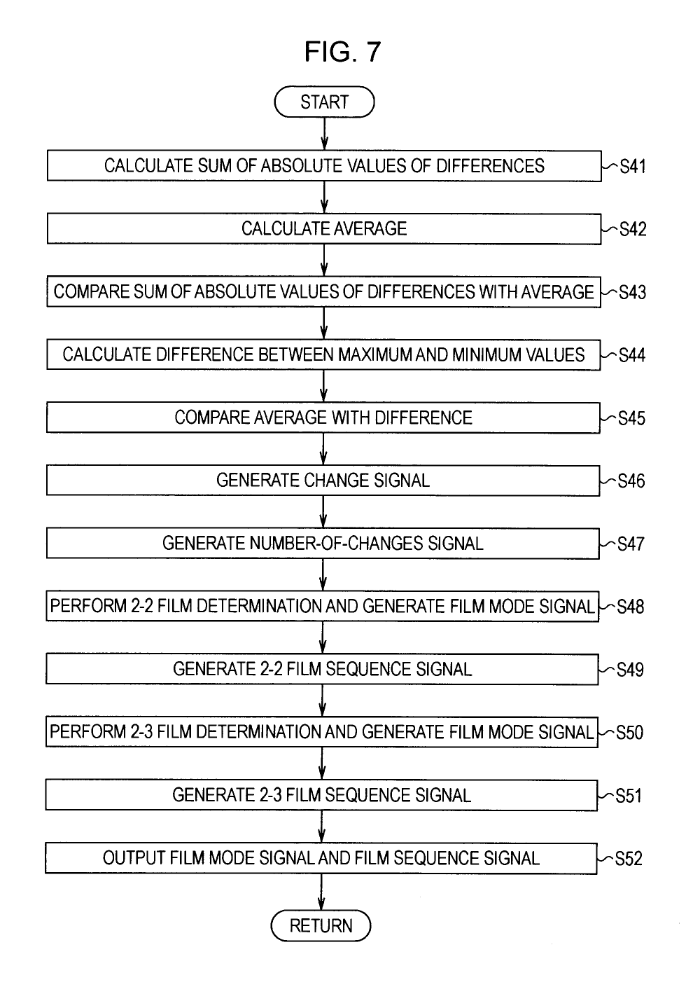

Next, with reference to a flowchart shown in FIG. 7, film mode determination processing corresponding to processing performed in step S12 in FIG. 6 will be described. This film mode determination processing is started when reduced images are supplied from the image reducing unit 31 and the frame memory 22 to the sum-of-absolute-values-of-differences calculation unit 61 of the film mode determination unit 32.

In step S41, the sum-of-absolute-values-of-differences calculation unit 61 calculates the sum of absolute values of differences between the supplied reduced images. That is, the sum-of-absolute-values-of-differences calculation unit 61 obtains luminance values of pixels of the reduced image supplied from the image reducing unit 31 and luminance values of pixels of the reduced image supplied from the frame memory 22, calculates luminance differences between corresponding pixels of the reduced images, and calculates the sum of absolute values of the calculated luminance differences as the sum of the absolute values of the differences. That is, a difference between the luminance value of each pixel of the reduced image supplied from the image reducing unit 31 and the luminance value of a corresponding one of the pixels of the reduced image supplied from the frame memory 22 is obtained, the corresponding one of the pixels being located at the same position as the pixel of the reduced image supplied from the image reducing unit 31, and the sum of absolute values of obtained luminance differences between the corresponding pixels is treated as the sum of the absolute values of the differences.

The sum-of-absolute-values-of-differences calculation unit 61 supplies the calculated sum of the absolute values of the differences dif-sum0 to the sum-of-absolute-values-of-differences delay unit 62. Then, the sum-of-absolute-values-of-differences delay unit 62 holds and delays the sum of the absolute values of the differences dif-sum0 supplied from the sum-of-absolute-values-of-differences calculation unit 61, and supplies the sum of the absolute values of the differences dif-sum0 and the sums of the absolute values of the differences dif-sum1 to dif-sum9 being held by the sum-of-absolute-values-of-differences delay unit 62, to the average calculation unit 63 and the interframe change detector 64.

In step S42, the average calculation unit 63 calculates the average dif-sum-ave of the sums of the absolute values of the differences dif-sum0 to dif-sum9 supplied from the sum-of-absolute-values-of-differences delay unit 62, and supplies the average dif-sum-ave to the threshold processing units 91 and the coefficient multiplier 92 of the interframe change detector 64. Moreover, the average calculation unit 63 obtains the maximum and minimum values of the sums of the absolute values of the differences dif-sum0 to dif-sum9 supplied from the sum-of-absolute-values-of-differences delay unit 62 and supplies the obtained maximum and minimum values to the interframe change detector 64 and the difference calculation unit 93.

In step S43, each of the threshold processing units 91-1 to 91-10 uses, as a threshold, the average dif-sum-ave supplied from the average calculation unit 63, and compares the average dif-sum-ave with a corresponding one of the sums of the absolute values of the differences supplied from the sum-of-absolute-values-of-differences delay unit 62. Then, each of the threshold processing units 91-1 to 91-10 supplies a one-bit signal having a value “1” to the coding unit 95 if the corresponding one of the sums of the absolute values of the differences is greater than or equal to the average dif-sum-ave. Each of the threshold processing units 91-1 to 91-10 supplies a one-bit signal having a value “0” to the coding unit 95 if the corresponding one of the sums of the absolute values of the differences is smaller than the average dif-sum-ave.

Here, a value of a signal indicating a result of threshold processing supplied from the threshold processing units 91 to the coding unit 95 indicates whether motion exists between frames.

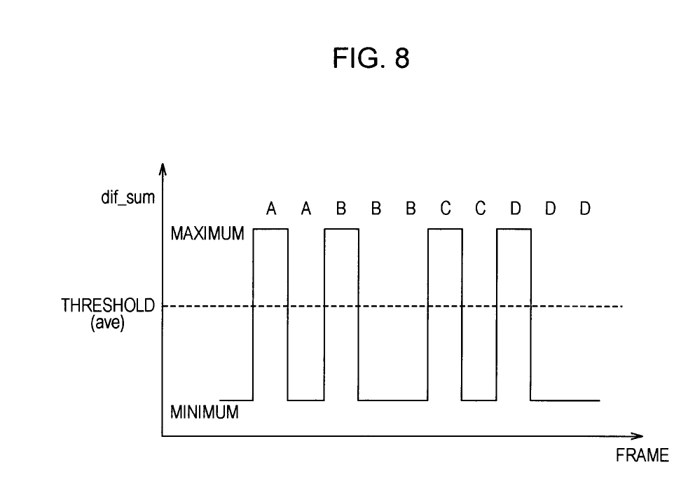

For example, as shown in FIG. 8, threshold processing is performed on the sum of absolute values of differences that is obtained for a reduced image generated from an input image whose film mode is “2-3 film”. Here, in FIG. 8, the vertical axis represents the sum of absolute values of differences that is obtained for the reduced image, and the horizontal axis represents time, that is, frame. Moreover, in FIG. 8, characters “A” to “D” represent reduced images and the broken straight line indicates the average of the sums of the absolute values of the differences.

In FIG. 8, in a case where a reduced image A of the leftmost frame is currently treated as a subject frame, a reduced image of a frame one frame previous to this frame is different from this reduced image A. Thus, motion exists between the frames, and the sum of the absolute values of the differences that is obtained for the subject frame has a value close to the maximum value of the sums of the absolute values of the differences.

Moreover, in a case where a reduced image A of a frame that is the second from the left is currently treated as a subject frame, since the reduced image A of the frame one frame previous to this frame is the same as the reduced image A of this frame, motion does not exist between the frames and the sum of the absolute values of the differences that is obtained for the subject frame is 0 (minimum value).

In this way, the sum of the absolute values of the differences for each frame whose reduced image has been generated from the input image whose film mode is “2-3 film” has a value close to either the maximum or minimum value in accordance with whether motion exists between frames. Thus, the average of the sums of the absolute values of the differences for the frames is almost the middle value between the maximum and minimum values. Thus, using this average as the threshold, whether motion exists between frames can be determined with certainty for each frame by comparing the sum of the absolute values of the differences that is obtained for the frame with the threshold.

Thus, for example, in a case where the reduced image A of the leftmost frame shown in FIG. 8 is currently treated as a subject image, since the reduced image A of the leftmost frame has the sum of the absolute values of the differences greater than the average, the threshold processing unit 91 that performs threshold processing on the sum of the absolute values of the differences that is obtained for this frame supplies, as a result of threshold processing, “1” indicating that motion exists between frames to the coding unit 95.

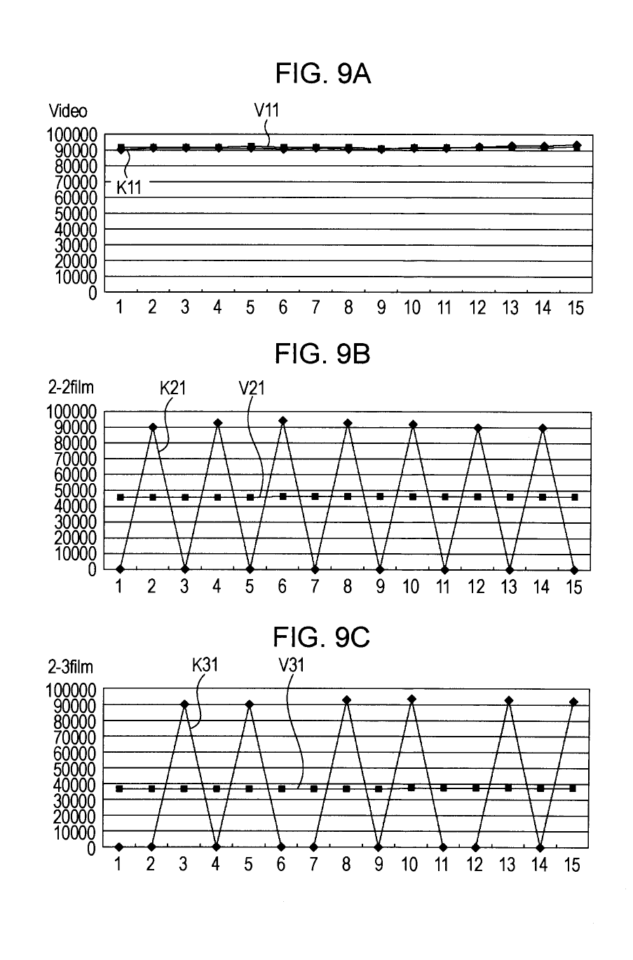

Moreover, FIGS. 9A to 9C each show the sum of absolute values of differences that is obtained for a reduced image that is actually generated from an input image of a corresponding one of the film modes. Here, in FIGS. 9A to 9C, the vertical axis represents the sum of absolute values of differences that is obtained for a reduced image, and the horizontal axis represents time, that is, frame.

FIG. 9A shows the sums of the absolute values of the differences for reduced images generated from an input image whose film mode is “Video” and the average of the sums of the absolute values of the differences. That is, in FIG. 9A, a curve K11 indicates the sum of the absolute values of the differences dif-sum of each frame, and a curve V11 indicates the average dif-sum-ave of the sums of the absolute values of the differences at each time.

If the film mode of an input image is “Video”, motion exists between frames for each frame, the sums of the absolute values of the differences for frames of reduced images are almost the same. Thus, the average of the sums of the absolute values of the differences is almost the same as the sums of the absolute values of the differences for the frames of the reduced images. Thus, even if threshold processing is performed on the sums of the absolute values of the differences using the average as the threshold, it is difficult to detect motion between frames of reduced images.

Moreover, FIG. 9B shows the sums of the absolute values of the differences for reduced images generated from an input image whose film mode is “2-2 film” and the average of the sums of the absolute values of the differences. That is, in FIG. 9B, a curve K21 indicates the sum of the absolute values of the differences dif-sum of each frame, and a curve V21 indicates the average dif-sum-ave of the sums of the absolute values of the differences at each time.

If the film mode of an input image is “2-2 film”, whether motion exists between frames of reduced images generated from the input image alternately changes from frame to frame. The sum of the absolute values of the differences for each frame is a value close to either the maximum or minimum value. Thus, the average of the sums of the absolute values of the differences is almost the middle value between the maximum and minimum values. Thus, if threshold processing is performed on the sums of the absolute values of the differences using the average as the threshold, whether motion exists between frames of reduced image can be determined with certainty for each frame.

Moreover, FIG. 9C shows the sums of the absolute values of the differences for frames of reduced images generated from an input image whose film mode is “2-3 film” and the average of the sums of the absolute values of the differences. That is, in FIG. 9C, a curve K31 indicates the sum of the absolute values of the differences dif-sum for each frame, and a curve V31 indicates the average dif-sum-ave of the sums of the absolute values of the differences at each time.

If the film mode of an input image is “2-3 film”, motion exists in a certain pattern in frames of reduced images generated from the input image. Thus, motion exists between frames for a frame and motion does not exist between frames for another frame. The sum of the absolute values of the differences for each frame is a value close to either the maximum or minimum value. Thus, the average of the sums of the absolute values of the differences is almost the middle value between the maximum and minimum values. Thus, if threshold processing is performed on the sums of the absolute values of the differences using the average as the threshold, whether motion exists between frames of reduced images can be determined with certainty for each frame.

In this way, by using the average of the sums of the absolute values of the differences that changes dynamically as the threshold for determining whether motion exists between frames of reduced images, a threshold appropriate for determining whether motion exists between frames can be set at each time for reduced images generated from an input image whose film mode is at least “2-2 film” or “2-3 film”.

Referring back to the flowchart shown in FIG. 7, in step S43, threshold processing is performed by the threshold processing units 91 and results of threshold processing are supplied from the threshold processing units 91 to the coding unit 95. Here, the threshold processing units 91-1 to 91-10 each output a signal indicating whether motion exists between frames for a corresponding one of the reduced images of the current frame through to the frame nine frames previous to the current frame.

For example, if the value of a signal output from the threshold processing unit 91-1 is “1”, the value indicates that motion exists between frames for the reduced image of the current frame. Moreover, for example, if the value of a signal output from the threshold processing unit 91-2 is “0”, the value indicates that motion does not exist between frames for the reduced image of a frame one frame previous to the current frame.

In step S44, the difference calculation unit 93 obtains a difference between the maximum and minimum values of the sums of the absolute values of the differences supplied from the average calculation unit 63 by subtracting the minimum value from the maximum value, and supplies the obtained difference to the comparator 94.

Moreover, the coefficient multiplier 92 multiplies the average supplied from the average calculation unit 63 by a coefficient, and supplies the resulting value to the comparator 94. Here, a reason for multiplying the average by a predetermined coefficient is to adjust the average to be a more appropriate value as a threshold used when whether the input image is regarded as a film movie is to be determined.

The threshold used for determining whether the input image is regarded as a film movie is desired to be a middle value between the maximum and minimum values of the sums of the absolute values of the differences. However, in a case of some input images, the minimum value of the sums of the absolute values of the differences is not 0, whereby the average is not the half the difference between the maximum and minimum values on every occasion. Moreover, for example, in a case of an input image (reduced images) whose film mode is “2-3 film”, the number of images that are repeatedly displayed is large, and thus the average of the sums of the absolute values of the differences is slightly smaller than the middle value between the maximum and minimum values. Thus, the average is multiplied by a predetermined coefficient and made to be an appropriate value as the threshold.

In step S45, the comparator 94 compares the average supplied from the coefficient multiplier 92 with the difference supplied from the difference calculation unit 93 and supplies a comparison result to the coding unit 95.

That is, if the difference supplied from the difference calculation unit 93 is greater than the average by a predetermined value or more, the comparator 94 supplies a value “1” indicating that the film mode of the input image (reduced images) is either “2-2 film” or “2-3 film” to the coding unit 95.

Moreover, if the difference supplied from the difference calculation unit 93 is not greater than the average by a predetermined value or more, the comparator 94 supplies a value “0” indicating that the film mode of the input image (reduced images) is “Video” to the coding unit 95. For example, if the film mode is “Video”, the difference between the maximum and minimum values is sufficiently smaller than the average. Thus, as the comparison result, the value “0” indicating that the film mode is “Video” is supplied to the coding unit 95.

In step S46, the coding unit 95 refers to the comparison result supplied from the comparator 94, and generates the change signal mdc in accordance with the results of threshold processing supplied from the threshold processing units 91-1 to 91-10.

More specifically, if a value “1” is supplied as a comparison result from the comparator 94, the coding unit 95 treats the film mode of the input image (reduced images) as “2-2 film” or “2-3 film” and treats a signal of ten bits that is obtained by arranging, in order, the results of threshold processing supplied from the threshold processing units 91 as the change signal mdc. Here, one-bit values supplied from the threshold processing units 91-1 to 91-10 correspond to the last (lowest) bit to the first (highest) bit of the change signal mdc, respectively.

Moreover, if a value “0” is supplied as a comparison result from the comparator 94, the coding unit 95 treats the film mode of the input image (reduced images) as “Video” and treats a signal of ten bits, each of which has a value “1”, as the change signal mdc. That is, if the film mode of the input image (reduced images) is “Video”, motion should be detected between frames for each frame, whereby a value of each bit of the change signal mdc is “1”.

If the change signal mdc is generated, the coding unit 95 supplies the generated change signal mdc to the adder 96 and the film pattern determination unit 65. In this way, since the change signal mdc is generated also utilizing the determination results regarding whether the input image is regarded as a film movie, false determination as to whether motion exists between frames can be reduced.

In step S47, the adder 96 generates the number-of-changes signal CHANGES from the change signal mdc by calculating the sum of values of bits of the change signal mdc supplied from the coding unit 95, and supplies the number-of-changes signal CHANGES to the film pattern determination unit 65. That is, the value of a predetermined bit of the change signal mdc is “1” if motion has been detected between frames for a frame of a reduced image corresponding to the bit, whereby the sum of values of the bits of the change signal mdc indicates the number of times motion has been detected between frames in the last ten frames of reduced images.

In step S48, the film pattern determination unit 65 performs “2-2 film” determination using the change signal mdc supplied from the coding unit 95 and the number-of-changes signal CHANGES supplied from the adder 96, and generates a film mode signal.

More specifically, if the value of the number-of-changes signal CHANGES supplied from the adder 96 is “5”, the number-of-changes determination unit 121 supplies a one-bit signal value “1” to the AND circuit 123. If the value of the number-of-changes signal CHANGES is not “5”, the number-of-changes determination unit 121 supplies a one-bit signal value “0” to the AND circuit 123.

Moreover, if the change signal mdc[1:0] supplied from the coding unit 95 matches the change signals mdc[3:2], mdc[5:4], mdc[7:6], and mdc[9:8] supplied from the coding unit 95, the comparators 122-1 to 122-4 supply signal values “1” to the AND circuit 123. If they do not match, the comparators 122-1 to 122-4 supply signal values “0” to the AND circuit 123.

The AND circuit 123 calculates the logical AND between a signal value supplied from the number-of-changes determination unit 121 and signal values supplied from the comparators 122-1 to 122-4, and supplies the result to the mode determination unit 124. That is, if all signal values supplied from the number-of-changes determination unit 121 and the comparators 122 are “1”, the AND circuit 123 supplies a one-bit value “1” to the mode determination unit 124. If signal values supplied from the number-of-changes determination unit 121 and the comparators 122 include “0”, the AND circuit 123 supplies a one-bit value “0” to the mode determination unit 124.

Furthermore, if a value “1” is supplied from the AND circuit 123, the mode determination unit 124 supplies a one-bit value “3” indicating that the film mode of the input image (reduced images) is “2-2 film”, as the film mode signal, to the output unit 131. If a value “0” is supplied from the AND circuit 123, the mode determination unit 124 supplies a one-bit value “1” indicating that the film mode of the input image (reduced images) is “Video”, as the film mode signal, to the output unit 131.

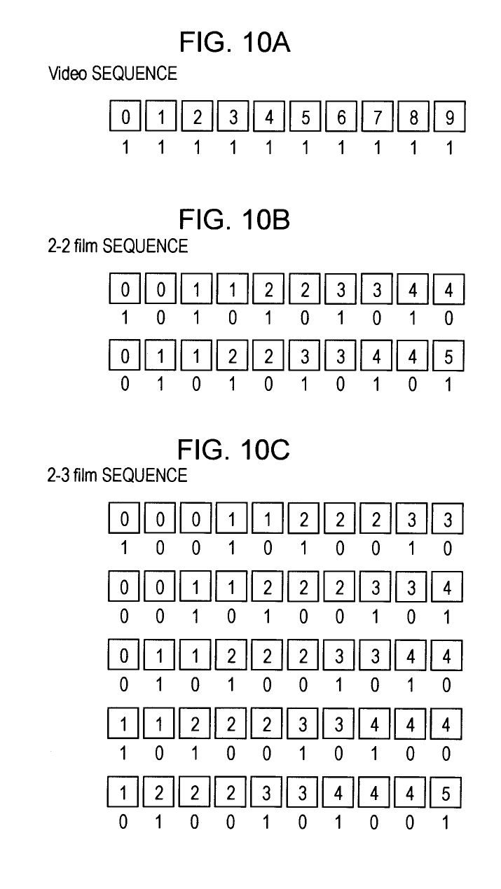

Here, as shown in FIGS. 10A to 10C, the film mode of the input image (reduced images) can be specified using the change signal mdc and the number-of-changes signal CHANGES. Here, in FIGS. 10A to 10C, the horizontal direction indicates time and each square shape represents one frame of the input image (reduced images).

Moreover, in FIGS. 10A to 10C, frames of images (reduced images) are arranged starting from a frame having the oldest display time in a direction from left to right in FIGS. 10A to 10C. Images represented by square shapes having the same number inside are the same image. Thus, the rightmost square shape represents an image of the current frame. Furthermore, in FIGS. 10A to 10C, a number “1” below a square shape indicates that motion exists between frames for an image (reduced image) of the frame. A number “0” below a square shape indicates that motion does not exist between frames for an image (reduced image) of the frame.

In FIG. 10A, an input image (reduced images) whose film mode is “Video” is shown. In this case, images of frames are different from each other, and thus motion between frames is detected for each frame. Thus, the value of the number-of-changes signal CHANGES is “10” and the value of each bit of the change signal mdc is “1”.

Thus, if the film mode is “Video”, a value output from the number-of-changes determination unit 121 is “0”, and values output from the comparators 122 are “1”. Thus, a value “0” is output from the AND circuit 123. As a result, the film mode signal whose value is “1” is output from the mode determination unit 124. The value “1” of this film mode signal indicates that the film mode is “Video”, whereby this means that the film mode of the input image has been properly determined.

In FIG. 10B, an input image (reduced images) whose film mode is “2-2 film” is shown.

If the film mode is “2-2 film”, images of two successive frames are the same. Thus, the current frame is either a temporally latter frame of two successive frames in which the same image is displayed as shown in the upper part of FIG. 10B or a temporally former frame of two successive frames in which the same image is displayed as shown in the lower part of FIG. 10B.

If the film mode is “2-2 film”, the number of times motion has been detected between frames in the last ten frames is five in both cases shown in the upper and lower parts of FIG. 10B. Thus, the value of the number-of-changes signal CHANGES is “5”.

Moreover, if the film mode is “2-2 film”, motion between frames is detected every other frame. Thus, the change signal mdc[1:0] is either “10”, or “01” and the change signal mdc[2i+1:2i] (where 1≦i≦4) is the same as the change signal mdc[1:0].

Thus, if the film mode is “2-2 film”, a value output from the number-of-changes determination unit 121 is “1” and values output from the comparators 122 are “1”. Thus, a value “1” is output from the AND circuit 123. As a result, the film mode signal whose value is “3”, is output from the mode determination unit 124. The value “3” of this film mode signal indicates that the film mode is “2-2 film”, whereby this means that the film mode of the input image has been properly determined.

In FIG. 10C, an input image (reduced images) whose film mode is “2-3 film” is shown.

If the film mode is “2-3 film”, images of two successive frames are the same and images of three successive frames are the same. Thus, as shown from the top row to the bottom row in order, the current frame is either a temporally latter frame of two successive frames in which the same image is displayed, a temporally first frame, a temporally middle frame, or a temporally last frame of three successive frames in which the same image is displayed, or a temporally former frame of two successive frames in which the same image is displayed.

If the film mode is “2-3 film”, the number of times motion has been detected between frames in the last ten frames is four in all cases shown from the top to the bottom row regarding the last ten frames in FIG. 10B. Thus, the value of the number-of-changes signal CHANGES is “4”.

Moreover, if the film mode is “2-3 film”, a display pattern of five successive frames is repeated. Thus, the change signals mdc[4:0] and mdc[9:5] are the same, and they are either “10010”, “00101”, “01010”, “10100”, or “01001”.

If the film mode of an input image (reduced images) is “2-3 film”, a value output from the number-of-changes determination unit 121 is “0”. Thus, a value “0” is output from the AND circuit 123. As a result, the film mode signal whose value is “1” is output from the mode determination unit 124. The value “1” of this film mode signal indicates that the film mode is “Video”. If the film mode has not been determined as “2-2 film” by the number-of-changes determination unit 121 through to the mode determination unit 124, the film mode of the input image is treated as “Video”.

Referring back to the flowchart shown in FIG. 7, if the “2-2 film” determination has been performed, in step S49, the sequence determination unit 125 generates the film sequence signal of “2-2 film” using the change signal mdc[1:0] supplied from the coding unit 95, and outputs the film sequence signal to the output unit 131.

That is, if the change signal mdc[1:0] is “10”, the sequence determination unit 125 generates a film sequence signal whose value is “0”. If the change signal mdc[1:0] is “01”, the sequence determination unit 125 generates a film sequence signal whose value is “1”. Here, if the change signal mdc[1:0] is “00” or “11”, the sequence determination unit 125 generates a film sequence signal whose value is “0”.

Here, the film sequence signal whose value is “0” indicates that the last ten frames of an input image (reduced images) have a display pattern shown in the upper portion of FIG. 10B. That is, this is a case where the current frame is a temporally latter frame of two successive frames in which the same image is displayed. Similarly, the film sequence signal whose value is “1” indicates that the last ten frames of an input image (reduced images) have a display pattern shown in the lower portion of FIG. 10B.

In this way, if the film mode of an input image is “2-2 film”, a film mode signal indicating the film mode “2-2 film” is output from the mode determination unit 124. Otherwise, a film mode signal indicating the film mode “Video” is output from the mode determination unit 124. Moreover, a film sequence signal for specifying a position of the current frame in a display pattern of the input image in a case where it is assumed that the film mode of the input image is “2-2 film” is output from the sequence determination unit 125.

As described above, if the “2-2 film” determination has been performed, in step S50, the film pattern determination unit 65 performs “2-3film” determination using the change signal mdc supplied from the coding unit 95 and the number-of-changes signal CHANGES supplied from the adder 96, and generates a film mode signal.

More specifically, if the value of the number-of-changes signal CHANGES supplied from the adder 96 is “4”, the number-of-changes determination unit 126 supplies a one-bit signal value “1” to the AND circuit 128. If the value of the number-of-changes signal CHANGES is not “4”, a one-bit signal value “0” is supplied to the AND circuit 128.

Moreover, if the change signal mdc[4:0] supplied from the coding unit 95 matches the change signal mdc[9:5], the comparator 127 supplies a signal value “1” to the AND circuit 128. If they do not match, the comparator 127 supplies a signal value “0” to the AND circuit 128.

Then, the AND circuit 128 calculates the logical AND between a signal value supplied from the number-of-changes determination unit 126 and a signal value supplied from the comparator 127, and supplies the result to the mode determination unit 129. That is, if both signal values supplied from the number-of-changes determination unit 126 and the comparator 127 are “1”, the AND circuit 128 supplies a one-bit value “1” to the mode determination unit 129. Otherwise, the AND circuit 128 supplies a one-bit value “0” to the mode determination unit 129.

For example, as shown in FIGS. 10A to 10C, the value of the number-of-changes signal CHANGES is “4” only when the film mode is “2-3 film”. Moreover, as shown in FIGS. 10A to 10C, the change signal mdc[4:0] matches the change signal mdc[9:5] only when the film mode is “2-3 film” or “Video”.

Thus, only when the film mode is “2-3 film”, a bit value “1” is output from the AND circuit 128. In other cases, a bit value “0” is output from the AND circuit 128.

Moreover, if a value “1” is supplied from the AND circuit 128 to the mode determination unit 129, the mode determination unit 129 supplies a one-bit value “2” indicating that the film mode of the input image (reduced images) is “2-3 film”, as a film mode signal, to the output unit 131. Moreover, if a value “0” is supplied from the AND circuit 128 to the mode determination unit 129, the mode determination unit 129 supplies a one-bit value “1” indicating that the film mode of the input image (reduced images) is “Video”, as a film mode signal, to the output unit 131.

In step S51, the sequence determination unit 130 generates the film sequence signal of “2-3 film” using the change signal mdc[4:0] supplied from the coding unit 95 and supplies the film sequence signal to the output unit 131.

That is, if the change signal mdc[4:0] is “10010”, the sequence determination unit 130 generates a film sequence signal whose value is “0”. If the change signal mdc[4:0] is “00101”, the sequence determination unit 130 generates a film sequence signal whose value is “1”.

Moreover, if the change signal mdc[4:0] is “01010”, the sequence determination unit 130 generates a film sequence signal whose value is “2”. If the change signal mdc[4:0] is “10100”, the sequence determination unit 130 generates a film sequence signal whose value is “3”. If the change signal mdc[4:0] is “01001”, the sequence determination unit 130 generates a film sequence signal whose value is “4”.

Here, with respect to display patterns of the last ten frames of the input image (reduced images), the film sequence signal whose value is “0” through to the film sequence signal whose value is “4” indicate display patterns shown from the top to the bottom row in FIG. 10C, respectively.

In this way, if the film mode of the input image is “2-3 film”, the film mode signal indicating the film mode “2-3 film” is output from the mode determination unit 129. Otherwise, the film mode signal indicating the film mode “Video” is output from the mode determination unit 129. Moreover, a film sequence signal for specifying a position of the current frame in a display pattern of the input image in a case where it is assumed that the film mode of the input image is “2-3 film” is output from the sequence determination unit 130.

In step S52, the output unit 131 outputs a final film mode signal and a final film sequence signal using the film mode signals supplied from the mode determination units 124 and 129 and the film sequence signals supplied from the sequence determination units 125 and 130.

More specifically, if a film mode signal whose value is “3” is supplied from the mode determination unit 124, the output unit 131 supplies, to the motion compensator 25, the film mode signal supplied from the mode determination unit 124 and the film sequence signal supplied from the sequence determination unit 125. In this case, as a result, the film mode is determined as “2-2 film”.

If a film mode signal whose value is “2” is supplied from the mode determination unit 129, the output unit 131 supplies, to the motion compensator 25, the film mode signal supplied from the mode determination unit 129 and the film sequence signal supplied from the sequence determination unit 130. In this case, as a result, the film mode is determined as “2-3 film”.

If a film mode signal whose value is “3” is not supplied from the mode determination unit 124 and a film mode signal whose value is “2” is not supplied from the mode determination unit 129, the output unit 131 supplies a film mode signal whose value is “1” and a film sequence signal whose value is “1” to the motion compensator 25. In this case, as a result, the film mode is determined as “Video”.

If a film mode signal and a film sequence signal are supplied from the output unit 131, film mode determination processing is completed. The procedure proceeds to step S13 in FIG. 6.

In this way, the film mode determination unit 32 determines whether motion exists between frames of reduced images (input image) and determines the film mode of the input image using the determination result.

In this way, the film mode can be determined more quickly and with more certainty by determining the film mode of the input image using the determination result as to whether motion exists between frames for the frames of the reduced images. That is, in the film mode determination unit 32, since it is necessary to perform only simple processing in which whether motion exists between frames for each frame is determined by performing comparison using arranged information items, each of which indicates whether motion exists for a corresponding one of the last ten frames, (change signal), the film mode is quickly determined. Moreover, since film mode determination is performed using information regarding ten frames, determination can be performed with higher precision.

Furthermore, whether motion exists between frames can be determined with more certainty by means of threshold processing by using the average of sums of the absolute values of the differences for the last ten frames as a threshold used when whether motion exists between frames is determined for each frame. Moreover, whether the input image is regarded as a film movie is determined by comparing the difference between the maximum and minimum values of the sums of the absolute values of the differences with the average. Thus, a final determination result as to whether motion exists between frames for each frame is obtained in accordance with this result and the result of threshold processing, and thus whether motion exists between frames can be determined with more certainty by using the final determination result.

Furthermore, in a case of film mode determination, not only information as to whether motion exists between frames for each frame obtained by performing comparison but also information regarding the number of times motion has been detected between frames in the last ten frames is used, whereby the precision of film mode determination can be improved.

Moreover, since the film mode can be more quickly determined in the image conversion apparatus 11, even in a case where the film mode of the input image being played back suddenly changes in the middle of playback, motion compensation can be promptly performed using a frame appropriate for a film mode obtained after the change. Thus, the image quality of the input image can be prevented from being degraded.

The film mode signal and the film sequence signal generated in film mode determination processing are utilized, in step S14 in FIG. 6, to specify one or more frames of the input image to be used for motion compensation.

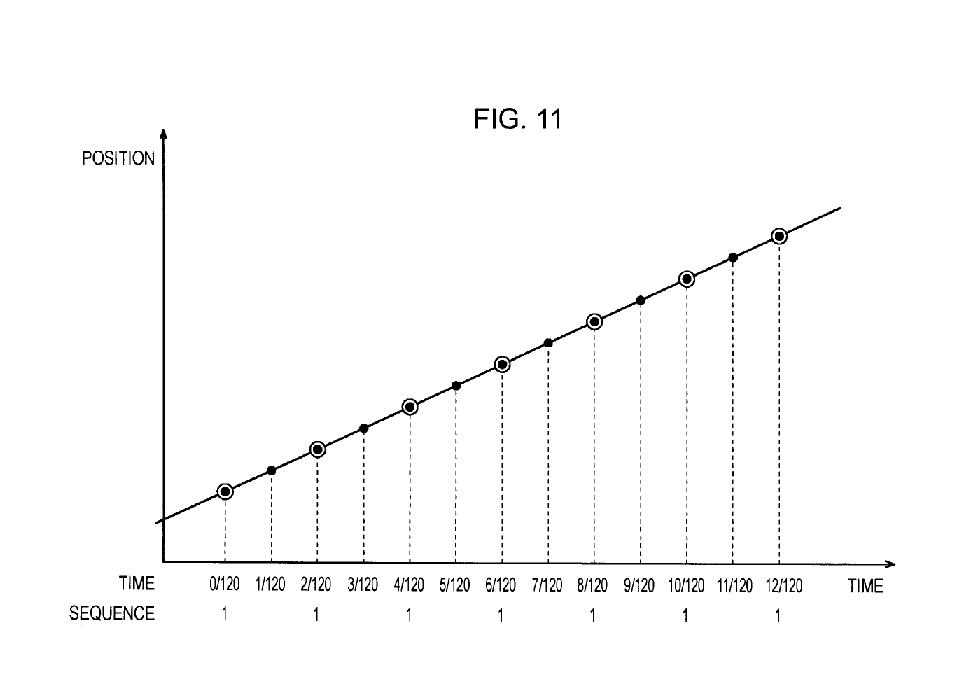

For example, as shown in FIG. 11, a case is assumed where an input image whose film mode is “Video” and whose frame rate is 60 Hz is converted into an input image whose frame rate is 120 Hz by frame rate conversion. Here, in FIG. 11, the vertical axis represents position on a frame of the input image and the horizontal axis represents time, that is, display time of each frame. Moreover, in FIG. 11, numbers in the top row along the horizontal axis represent time and numbers in the bottom row along the horizontal axis represent value of a film sequence signal.

Furthermore, circles that are not shaded represent a movement object on frames of the input image obtained before frame rate conversion is performed, and circles that are shaded represent the movement object on frames of an input image obtained after frame rate conversion is performed.

In the film mode “Video”, the same image is not displayed in successive frames. Thus, an image of an interpolation frame can be generated using images of two successive frames, the interpolation frame being to be positioned between the two successive frames.

For example, when a display time of the current frame is a time 2/120, if an interpolation frame for a time 1/120 is generated using an image of the current frame included in the input image and an image of a frame included in the input image and obtained at a time 0/120, frame interpolation is appropriately performed. That is, an image of the interpolation frame is generated in which a movement object for the time 1/120 is positioned on an imaginary straight line that connects the movement object obtained at the time 0/120 and the movement object obtained at the time 2/120.

Thus, if the film mode is “Video”, that is, if the value of the film mode signal is “1”, motion compensation should be performed using an image and motion vectors of a frame obtained when the value of the film sequence signal is “1”.

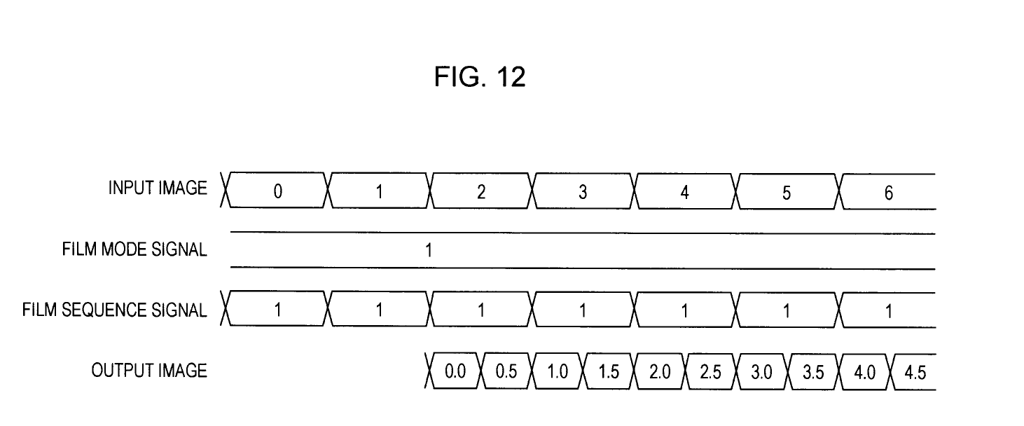

In this way, if an interpolation frame is generated using the current frame and a frame one frame previous to the current frame, for example, as shown in FIG. 12, an input image having an interpolation frame that is interpolated between the two successive frames is generated.

Here, in FIG. 12, an input image, a film mode signal, a film sequence signal, and an input image whose frame rate has been converted (hereinafter referred to as an “output image”) are shown from the top to the bottom row, and the horizontal direction indicates time.

In FIG. 12, an input image in which frames are horizontally arranged is shown in the top row, and each number indicates one frame included in the input image. Similarly, in FIG. 12, an output image in which frames are horizontally arranged is shown in the bottom row, and each number indicates one frame included in the output image. Moreover, the film mode of the input image is “Video”, whereby the value of the film mode signal and the value of the film sequence signal are “1” on every occasion.

In the image conversion apparatus 11, an image “0” of the input image is simply output as an image “0.0” of the output image at a time when an image “2” of the input image is input. That is, the image “0” of the input image is delayed by a time period during which two frames are displayed by means of various image processing and output as the image “0.0” of the output image. Moreover, an image “0.5” of the output image is generated and output using an image “1” age “0” of the input image and motion vectors of the image “0”. Furthermore, the image “1” of the input image is output as an image “1.0” of the output image. Then, thereafter, interpolation frames are similarly generated.

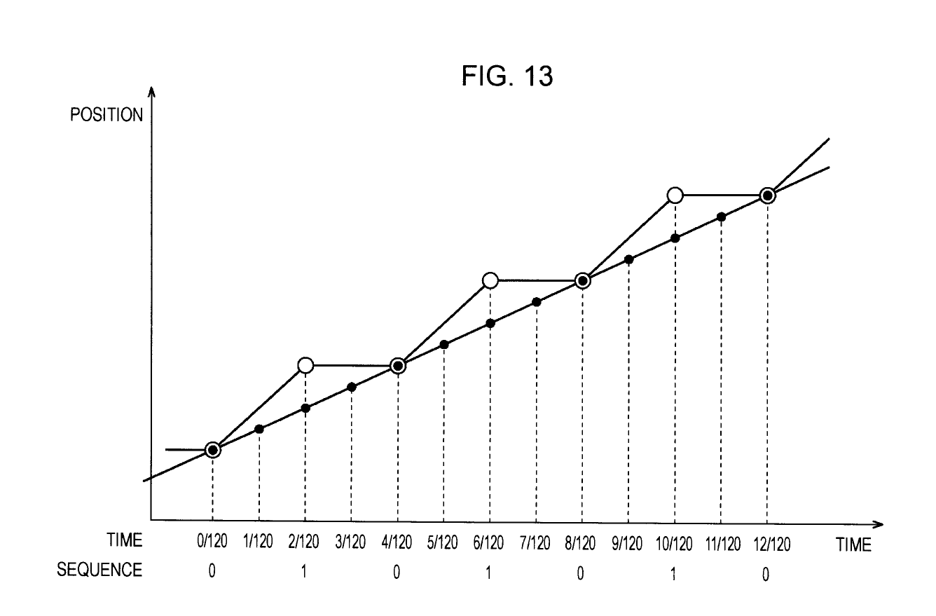

Moreover, for example, as shown in FIG. 13, a case is assumed where an input image whose film mode is “2-2 film” and that is obtained by converting the frame rate of a moving image from 30 Hz to 60 Hz is further converted into an input image having a frame rate of 120 Hz by frame rate conversion. Here, in FIG. 13, the vertical axis represents position in a frame of an input image and the horizontal axis represents time, that is, display time of each frame. Moreover, in FIG. 13, numbers in the top row along the horizontal axis represent time and numbers in the bottom row along the horizontal axis represent value of a film sequence signal.

Furthermore, circles that are not shaded represent a movement object on frames of the input image obtained before frame rate conversion is performed, and circles that are shaded represent the movement object on frames of an input image obtained after frame rate conversion is performed.

In the film mode “2-2 film”, the same image is displayed in two successive frames. Thus, an image of an interpolation frame should be generated using a temporally latter frame of the two successive frames in which the same image is displayed.

For example, in a case where a time 4/120 is a display time of the current frame, if interpolation frames for times 1/120, 2/120, and 3/120 are generated using the image of the current frame and an image of a frame obtained at a time 0/120, frame interpolation is appropriately performed. That is, images of the interpolation frames are generated in which movement objects for the times 1/120, 2/120, and 3/120 are positioned on an imaginary straight line that connects the movement object obtained at the time 0/120 and the movement object obtained at the time 4/120. Here, in a case of generating interpolation frames, motion vectors of the frame of the input image obtained at the time 0/120 are used.

As described above, if the film mode is “2-2 film”, that is, if the value of a film mode signal is “3”, motion compensation should be performed using an image of a frame obtained when the value of a film sequence signal is “0”, and motion vectors of the image.

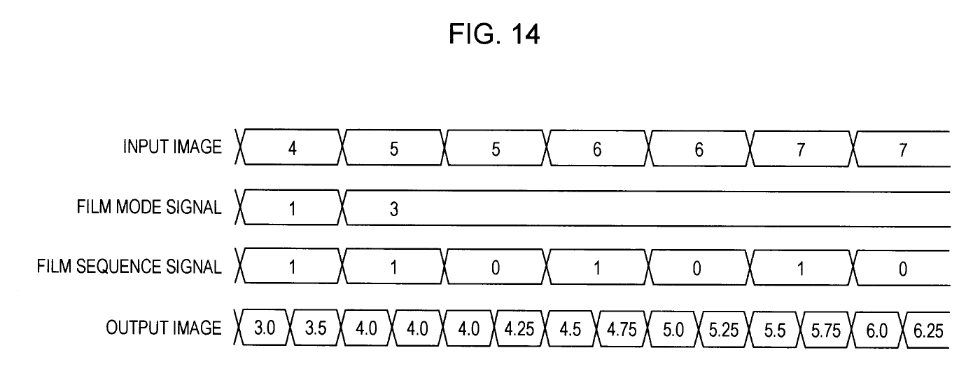

In this way, if an interpolation frame is generated using a temporally latter frame of two frames in which the same image is repeatedly displayed, for example, as shown in FIG. 14, an input image is generated in which frames between a predetermined frame and a frame two frames previous to the predetermined frame are interpolated.

Here, in FIG. 14, an input image, a film mode signal, a film sequence signal, and an input image on which frame rate conversion has been performed (output image) are shown from the top to the bottom row in FIG. 14. The horizontal direction indicates time.

In FIG. 14, an input image in which frames are horizontally arranged is shown in the top row, and each number represents one frame included in the input image. Similarly, in FIG. 14, an output image in which frames are horizontally arranged is shown in the bottom row, and each number represents one frame included in the output image.

The film mode of the input image is “2-2 film”. Thus, in and after the eleventh frame that enables “2-2 film” determination, that is, in and after a frame of an image “5” included in the input image, the value of the film mode signal becomes “3” and the value of the film sequence signal becomes “0” or “1”.

In the image conversion apparatus 11, the image “5” included in the input image and obtained when the value of the film sequence signal is “0” is simply output as an image “5.0” of the output image at a time when an image “6” included in the input image and obtained when the value of the film sequence signal is “0” is input. That is, the image “5” included in the input image is delayed by a time period during which two frames are displayed by means of various image processing and output as the image “5.0” of the output image.

Moreover, the images “5” and “6” included in the input image and obtained when the value of the film sequence signal is “0” and the motion vectors of the image “5” included in the input image and obtained when the value of the film sequence signal is “0” are used to generate images “5.25” to “5.75” of the output image. The images “5.25” to “5.75” are output. Furthermore, the image “6” included in the input image and obtained when the value of the film sequence signal is “0” is output as an image “6.0” of the output image. Thereafter, interpolation frames are similarly generated.

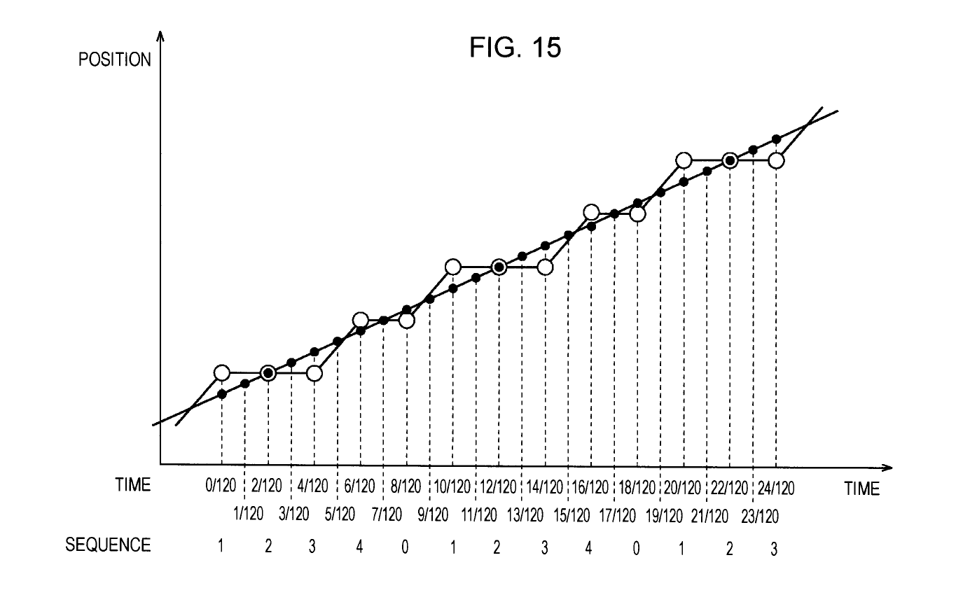

Furthermore, for example, as shown in FIG. 15, a case is assumed where an input image whose film mode is “2-3 film” and that is obtained by converting the frame rate of a moving image from 24 Hz to 60 Hz is further converted into an input image having a frame rate of 120 Hz by frame rate conversion. Here, in FIG. 15, the vertical axis represents position on a frame of the input image and the horizontal axis represents time, that is, display time of each frame. Moreover, in FIG. 15, numbers in the top row along the horizontal axis represent time and numbers in the bottom row along the horizontal axis represent value of a film sequence signal.

Furthermore, circles that are not shaded represent a movement object on frames of the input image obtained before frame rate conversion is performed, and circles that are shaded represent the movement object on frames of an input image obtained after frame rate conversion is performed.

In the film mode “2-3 film”, the same image is displayed in two or three successive frames. Thus, for example, an interpolation frame should be generated using a temporally middle frame from among three successive frames in which the same image is repeatedly displayed and a temporally latter frame of two successive frames in which the same image is repeatedly displayed.

For example, in a case where a time 12/120 is a display time of the current frame, if interpolation frames for times 3/120 to 11/120 are generated using an image of the current frame included in the input image, an image of a frame included in the input image and obtained at a time 8/120, and an image of a frame included in the input image and obtained at a time 2/120, frame interpolation is appropriately performed. That is, images of the interpolation frames are generated in which movement objects for the times 3/120 to 11/120 are positioned on an imaginary straight line that connects the movement object obtained at the time 2/120 and the movement object obtained at the time 12/120.

Here, in a case of interpolating frames, motion vectors of images included in the input image and obtained at times 8/120 and 4/120 are used. That is, in a case of interpolating frames, motion vectors of an image of the frame included in the input image and obtained at the time 2/120 are detected using the image of the frame obtained at the time 2/120 and an image of a frame included in the input image and obtained at the time 4/120. Since the image of the frame included in the input image and obtained at the time 2/120 is the same as the image of the frame included in the input image and obtained at the time 4/120, motion vectors are 0. Thus, if motion vectors of the image included in the input image and obtained at the time 2/120 are used, frame interpolation is not properly performed.

Moreover, motion vectors that are necessary in a case of interpolating frames are motion vectors detected using the images included in the input image and obtained at the time 2/120 and the time 8/120. Thus, in a case of interpolating frames, motion vectors of the image included in the input image and obtained at the time 4/120 are used, which are the same as the motion vectors detected using the images included in the input image and obtained at the time 2/120 and the time 8/120.

As described above, if the film mode is “2-3 film”, that is, if the value of the film mode signal is “2”, motion compensation should be performed using images of frames included in the input image and obtained when the value of the film sequence signal is “0” and when the value of the film sequence signal is “2” and motion vectors of images of frames included in the input image and obtained when the value of the film sequence signal is “0” and when the value of the film sequence signal is “3”.

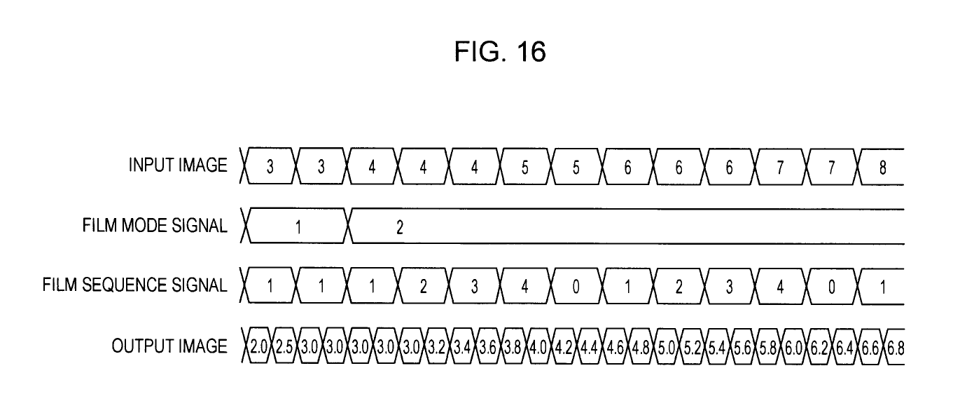

In this way, if an interpolation frame is generated using images of three frames included in the input image, for example, as shown in FIG. 16, an input image is generated in which frames between a predetermined frame and a frame five frames previous to the predetermined frame are interpolated.

Here, in FIG. 16, an input image, a film mode signal, a film sequence signal, and an input image on which frame rate conversion has been performed (output image) are shown from the top to the bottom row in FIG. 16. The horizontal direction indicates time.

In FIG. 16, an input image in which frames are horizontally arranged is shown in the top row, and each number represents one frame included in the input image. Similarly, in FIG. 16, an output image in which frames are horizontally arranged is shown in the bottom row, and each number represents one frame included in the output image.

The film mode of the input image is “2-3 film”. Thus, in and after the eleventh frame that enables “2-3 film” determination, that is, in and after a frame of an image “4” included in the input image, the value of the film mode signal becomes “2” and the value of the film sequence signal becomes one of “0” to “4”.

In the image conversion apparatus 11, the image “4” included in the input image and obtained when the value of the film sequence signal is “2”, is simply output as an image “4.0” of the output image at a time when an image “5” included in the input image and obtained when the value of the film sequence signal is “4” is input. That is, the image “4” included in the input image is delayed by a time period during which two frames are displayed by means of various image processing and output as the image “4.0”, of the output image.

Moreover, the images “4” and “6” included in the input image and obtained when the value of the film sequence signal is “2”, the image “5” included in the input image and obtained when the value of the film sequence signal is “0”, motion vectors of the image “4” included in the input image and obtained when the value of the film sequence signal is “3”, and motion vectors of the image “5” included in the input image and obtained when the value of the film sequence signal is “0” are used to generate images “4.2” to “5.8”, of the output image. The images “4.2” to “5.8” are output. Furthermore, the image “6” included in the input image and obtained when the value of the film sequence signal is “2” is output as an image “6.0” of the output image. Thereafter, interpolation frames are similarly generated.

As described above, in the motion compensator 25, interpolation frames are generated using images and motion vectors of frames included in the input image and specified by a film mode signal and a film sequence signal.

In this way, by specifying frames and motion vectors to be used for generation of interpolation frames in accordance with a film mode signal and a film sequence signal, frames and motion vectors that are more appropriate for generation of interpolation frames can simply be selected with certainty. Thus, the image quality of the input image can be prevented from being degraded.

Although the motion compensator 25 selects motion vectors to be used for motion compensation (generation of interpolation frames) using a film mode signal and a film sequence signal in the above description, the motion vector detector 23 may detect only certain motion vectors that are necessary.

In such a case, for example, a film mode signal and a film sequence signal are supplied to the motion vector detector 23 from the film mode determination unit 32. Then, the motion vector detector 23 detects motion vectors of an image of a frame included in the input image and specified by the supplied film mode signal and film sequence signal, and supplies the motion vectors to the motion compensator 25.

Moreover, an input image to be subjected to frame rate conversion is not limited to a progressive image, and may be an interlace image.

For example, in the image conversion apparatus 11, an interlace input image is converted into a progressive image, and then frame rate conversion may further be performed on the progressive image. Moreover, for example, in the image conversion apparatus 11, a phase alternation by line (PAL) input image may be converted into a National Television System Committee (NTSC) image by frame rate conversion. If an input image is an interlace image, frame rate conversion is performed using an image of each field.

The above-described series of processing processes may be executed by hardware or software. If the series of processing processes is executed by software, a program that constitutes the software is installed from a program recording medium onto a computer that is built in dedicated hardware, a general purpose personal computer, for example, capable of executing various functions using various programs being installed thereon, or the like.

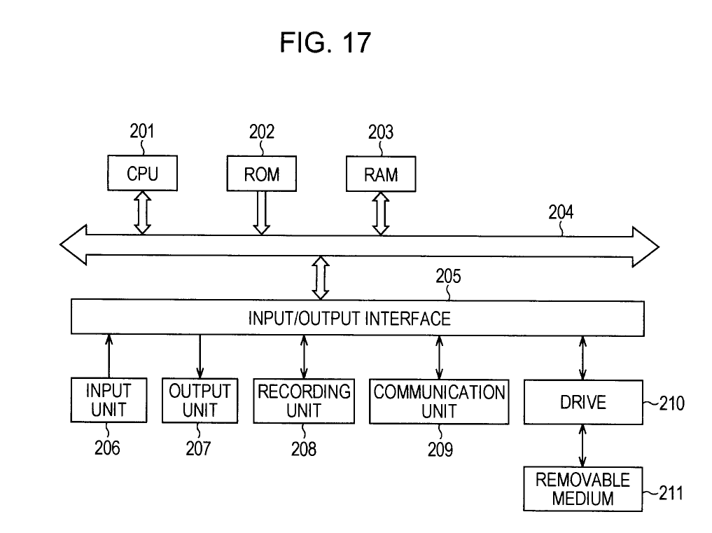

FIG. 17 is a block diagram showing an exemplary structure of hardware of a computer that executes the above-described series of processing processes.

In the computer, a central processing unit (CPU) 201, a read-only memory (ROM) 202, and a random access memory (RAM) 203 are connected to each other via a bus 204.

In addition, an input/output interface 205 is connected to the bus 204. An input unit 206 including a keyboard, a mouse, and a microphone, an output unit 207 including a display and a speaker, a recording unit 208 including a hard disk and a nonvolatile memory, a communication unit 209 including a network interface, and a drive 210 for driving a removable medium 211 such as a magnetic disk, an optical disc, a magneto-optical disk, and a semiconductor memory are connected to the input/output interface 205.

In the computer configured as described above, for example, the above-described series of processing processes is performed by loading a program recorded in the recording unit 208 into the RAM 203 via the input/output interface 205 and the bus 204 and executing the program, the loading and executing being performed by the CPU 201.

The program to be executed by the computer (CPU 201) is provided via a wired or wireless transmission medium, for example, by using the removable medium 211, which is a packaged medium and in which the program is recorded, such as a magnetic disk (including a flexible disk), an optical disc (such as a compact disc-read-only memory (CD-ROM) or a digital versatile disc (DVD)), a magneto-optical disk, or a semiconductor memory, or by using a local area network, the Internet, Digital Satellite Broadcasting, or the like.

The program can be installed onto the recording unit 208 via the input/output interface 205 by mounting the removable medium 211 into the drive 210. Moreover, the program can be received at the communication unit 209 via a wired or wireless transmission medium and can be installed onto the recording unit 208. The program may be installed onto the ROM 202 or the recording unit 208 in advance.

Here, the program to be executed by the computer may be a program that executes the above-described series of the processing processes in a time-series order as described herein or may be a program that executes processing processes in parallel or executes each processing process at a necessary time, for example, when the processing process is invoked.

The present application contains subject matter related to that disclosed in Japanese Priority Patent Application JP 2008-168235 filed in the Japan Patent Office on Jun. 27, 2008, the entire content of which is hereby incorporated by reference.

Here, embodiments of the present invention are not limited to the above-described embodiments. Various changes can be made within the scope of the gist of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
difference calculation means for obtaining a luminance difference between images of two successive frames;
average calculation means for calculating the average of luminance differences obtained for a predetermined number of successive frames, each of the luminance differences being obtained for a corresponding one of the predetermined number of the successive frames;
change determination means for determining, for each frame of the predetermined number of the successive frames, whether images of two successive frames including the frame are the same by comparing the luminance difference obtained for the frame with the average; and
display pattern determination means for determining a temporal display pattern of images of the predetermined number of the successive frames from among a plurality of display patterns including a display pattern in which groups each having a certain number of successive frames in which the same image is displayed are regularly repeated, using a determination result regarding the predetermined number of the frames, the determination result being obtained by the change determination means.

2. The image processing apparatus according to claim 1, further comprising:
frame interpolation means for performing motion compensation using an image of a first frame and an image of a second frame specified, from among the images of the predetermined number of the frames, by a determination result obtained by the change determination means and a determination result regarding the display pattern, and for generating an image of a frame to be interpolated between the first and second frames.

3. The image processing apparatus according to claim 1, further comprising:
comparison means for comparing a difference between the maximum and minimum values of the luminance differences obtained for the predetermined number of the frames with the average,
wherein the display pattern determination means determines the display pattern using the determination result obtained by the change determination means and a comparison result obtained by the comparison means.

4. The image processing apparatus according to claim 1, further comprising:
number-of-times calculation means for obtaining the number of times the same image is displayed in the predetermined number of the frames using the determination result obtained by the change determination means,
wherein the display pattern determination means determines the display pattern using the determination result obtained by the change determination means and the result regarding the number of times the same image is displayed obtained by the number-of-times calculation means.

5. The image processing apparatus according to claim 1, further comprising:
reduced image generation means for generating a reduced image of an image by reducing the number of pixels of the image,
wherein the difference calculation means obtains the luminance difference using the reduced image.

6. An image processing method for an image processing apparatus, the image processing apparatus including
difference calculation means for obtaining a luminance difference between images of two successive frames;
average calculation means for calculating the average of luminance differences obtained for a predetermined number of successive frames, each of the luminance differences being obtained for a corresponding one of the predetermined number of the successive frames;
change determination means for determining, for each frame of the predetermined number of the successive frames, whether images of two successive frames including the frame are the same by comparing the luminance difference obtained for the frame with the average; and
display pattern determination means for determining a temporal display pattern of images of the predetermined number of the successive frames from among a plurality of display patterns including a display pattern in which groups each having a certain number of successive frames in which the same image is displayed are regularly repeated, using a determination result regarding the predetermined number of the frames, the determination result being obtained by the change determination means, the image processing method comprising the steps of:
obtaining the luminance difference using the difference calculation means;
calculating the average using the average calculation means;
comparing the luminance difference with the average and determining whether the images of the two successive frames are the same using the change determination means; and
determining the display pattern using the display pattern determination means.

7. A program for causing a computer to execute processing comprising the steps of:
obtaining a luminance difference between images of two successive frames;
calculating the average of luminance differences obtained for a predetermined number of successive frames, each of the luminance differences being obtained for a corresponding one of the predetermined number of the successive frames;
determining, for each frame of the predetermined number of the successive frames, whether images of two successive frames including the frame are the same by comparing the luminance difference obtained for the frame with the average; and
determining a temporal display pattern of images of the predetermined number of the successive frames from among a plurality of display patterns including a display pattern in which groups each having a certain number of successive frames in which the same image is displayed are regularly repeated, using a determination result regarding the predetermined number of the frames, the determination result being obtained in the step of determining whether the images of the two successive frames including the frame are the same.

8. An image processing apparatus comprising:
a difference calculation unit that obtains a luminance difference between images of two successive frames;
an average calculation unit that calculates the average of luminance differences obtained for a predetermined number of successive frames, each of the luminance differences being obtained for a corresponding one of the predetermined number of the successive frames;
a change determination unit that determines, for each frame of the predetermined number of the successive frames, whether images of two successive frames including the frame are the same by comparing the luminance difference obtained for the frame with the average; and
a display pattern determination unit that determines a temporal display pattern of images of the predetermined number of the successive frames from among a plurality of display patterns including a display pattern in which groups each having a certain number of successive frames in which the same image is displayed are regularly repeated, using a determination result regarding the predetermined number of the frames, the determination result being obtained by the change determination unit.
